(19) United States
(12) Patent Application Publication
(10) Pub. No.: US 2010/0171862 A1
(43) Pub. Date: Jul. 8, 2010

(54) Parallax Camera and Display Screen

(76) Inventor: Earl Alexander Culham, Edmonton (CA)

Correspondence Address: Earl Alexander Culham, 12539 - 161 Avenue NW, Edmonton, Alberta, T5X 4W7, omitted

(21) Appl. No.: 12/652,731

(22) Filed: Jan. 5, 2010

Related U.S. Application Data
(60) Provisional application No. 61/204,271, filed on Jan. 6, 2009.

(51) Int. Cl. H04N 5/222; G09G 3/00

(52) U.S. Cl. 348/333.09; 345/30; 348/E05.022

(57) ABSTRACT

In the beginning, display screens were monochrome, and a video artist was limited to specifying the brightness of a pixel. With the advent of color display screens, the artist could specify the color and brightness of a pixel. With this invention, the artist can now additionally specify the direction from which that color and brightness can be seen. I anticipate a single pixel being capable of displaying different colors in different directions at the same time. This invention also describes a camera capable of capturing this directional information.

### CROSS REFERENCE TO RELATED APPLICATIONS

Provisional Patent Application No. 61/204,271,

Filed Jan. 6, 2009, Earl Alexander Culham,

Parallax Camera and Display Screen

### FIELD OF THE INVENTION

The present invention relates to a method of capturing, manipulating, storing, transmitting, and displaying video information.

### BACKGROUND OF THE INVENTION

Display Screens display video information.

As is well known in the prior art, the image on the display consists of many individual dots, typically called pixels. On some displays, the color of the pixel can be specified. On some displays, it is possible to simulate motion by the sequential display of changing information. If it changes fast enough, this gives the illusion of motion.

Even with these refinements, all prior display screens retain a flaw that has been passed down since the earliest cave paintings. It is really hard to show depth, and even harder to show parallax.

No matter how skillfully any artist paints a picture showing depth and perspective, you can shatter the illusion by the simple expedient of moving your head. The painting is not displaying the parallax. You wouldn't likely mistake a painting for a window.

In contrast, it is easy to mistake a mirror for a window. With a mirror, as well as with the window, the image you see is, in part, determined by the location from where you are looking. The image changes as you move.

The basic limitation is that all display screens known to the prior art display the same image to multiple viewers. If your goal is to give a theatre full of people a shared experience, then that limitation is tolerable, even though it means they have to stay seated. If your goal is to provide a lifelike view then that limitation is a large flaw, especially when it comes to displaying the parallax inherent in a Three-Dimensional scene.

Various attempts have been made to solve this Three-Dimensional problem. In the prior art these are typically called Stereoscopic Displays. They can be boiled down to this. They make two images, and project them so that one image hits one eye and the other image hits the other eye. The fact that this only partially solves the problem can again be made obvious by simply moving your head. The image reacts to your movement like a painting would, rather than like a window would. The parallax is lacking. The illusion of depth perception is shattered.

In other prior art, typically called Virtual Reality, the position of the head is sensed, and the image displayed is recalculated to match that new position. This leads to the natural extension of refining it from sensing the head to sensing the eyeball, or even sensing the focusing of the lens within the eyeball. All that refinement still leaves the limitation that all of this sensing and recalculating is only useful for the position of one eyeball. It has to be displayed differently for every other eye or pairs of eyes. It is useless as a multi-user display.

The basic limitation is that all display screens known to the prior art display the same image to multiple viewers. They may combine two images so that there is one image for everyone's left eye, and another image for everyone's right eye. But, the basic limitation remains. As you change the location from which you view the display screen, the image seen behaves like a painting, not like a window. The parallax motion, which you expect from a window, does not exist in any painting.

In other prior art, typically called First Order Holograms, an image is created that does behave like a window. By splitting a monochromatic source of light into two beams, recombining them to illuminate the target object from two different directions, then capturing that illuminated image on light sensitive film, they create an image called a First Order Hologram. When later properly lit with the same monochromatic source of light, the film behaves like a window, through which you can view the original object, complete with the fact that the image viewed changes naturally as the location of the viewer changes. However, the limitation, that the film must be lit with only that same wavelength of light as was used to create it, makes first order holograms useless as a general-purpose display screen. Also, the requirement for a monochromatic source of light limits the image being viewed to consist of only one color, much like a black and white photograph.

In other prior art, typically called Lenticular Printing, two or more pictures are sliced into thin vertical strips which are then interleaved onto the back of a clear plastic coating while thin vertical prisms are impressed into the front of that clear plastic coating. This gives two or more distinct images, which can be arranged to provide one picture to one eye and another picture to another eye. Again, the simple expedient of moving your head, and especially the motions of tilting your head or moving your head up and down, will reveal that this prior art does not properly display parallax.

In other prior art, typically called a Parallax Grid, each pixel is divided into two sources of light with a barrier between them. The purpose of the barrier is to block the light so that each eye can see only one of the two sources of light. Again, the simple expedient of moving your head, and especially the motions of tilting your head or moving your head up and down, will reveal that this prior art does not properly display parallax.

In other prior art, typically called Plenoptics, an optical lens focuses an image onto a grid of holes with optical sensors positioned behind those holes. This setup creates a filter in which the portion of the image which is accurately focused makes it through the holes of the grid, and the less accurately focused part of the image is filtered. This is a useful tool for separating the image of an object from the general background. However, because of the limitation that the light must pass through a lens to focus it on the grid, the parallax information is lost. Every hole in the grid is receiving light from all points within the lens. A Plenoptics camera can never capture the information needed to properly display parallax.

### BRIEF SUMMARY OF THE INVENTION

The present invention relates to a new type of display screen, and to a new type of camera to collect the information to be displayed on this new type of display screen.

This invention discloses a way to construct a display screen so that it can behave like a window. In particular, this new type of display screen displays the parallax information inherent in a window. As you move your head, the image changes. By the way, it can also be made to behave in ways that no window or mirror could ever imitate.

According to the present invention there is provided a method of constructing a display screen such that the content of image being seen is uniquely dependent on the position of the eye that is seeing that image.

For every pixel there is now a new attribute, called direction. In the prior art, the artist could specify the color and brightness of a pixel. With the Parallax Display Screen, the artist can now also specify the direction from which that color and brightness can be seen. In many embodiments of this invention, each pixel can be sending many different colors at the same time. Each color travels out from the pixel in a different direction. For each direction, the color can be unique.

If you start with a light source that is highly directed, such as the light from lasers, then a Parallax Display Screen can be constructed by simply mounting the lasers pointing in the required directions.

If the light source is too dispersed, it can be attenuated by passing through an aperture. An aspect of this invention is that several light sources can share a single aperture, with each light source attenuated to a different direction.

### BRIEF DESCRIPTION OF THE DRAWINGS

FIG. 1. is a cut-away view of the layers in the Preferred Embodiment. The base (1) is a grid with patches of light emitting diodes, interleaved with patches of photoreceptors. An opaque layer (2) is applied over the base (1). On top of this is a thin but strong opaque layer (3). In the thin but strong layer (3) there are small apertures (4). Under each of these apertures (4) there are caverns (5) etched into the opaque layer (2), exposing unobstructed paths from the electronics in the base (1) through the apertures (4) in the thin but strong opaque layer (3).

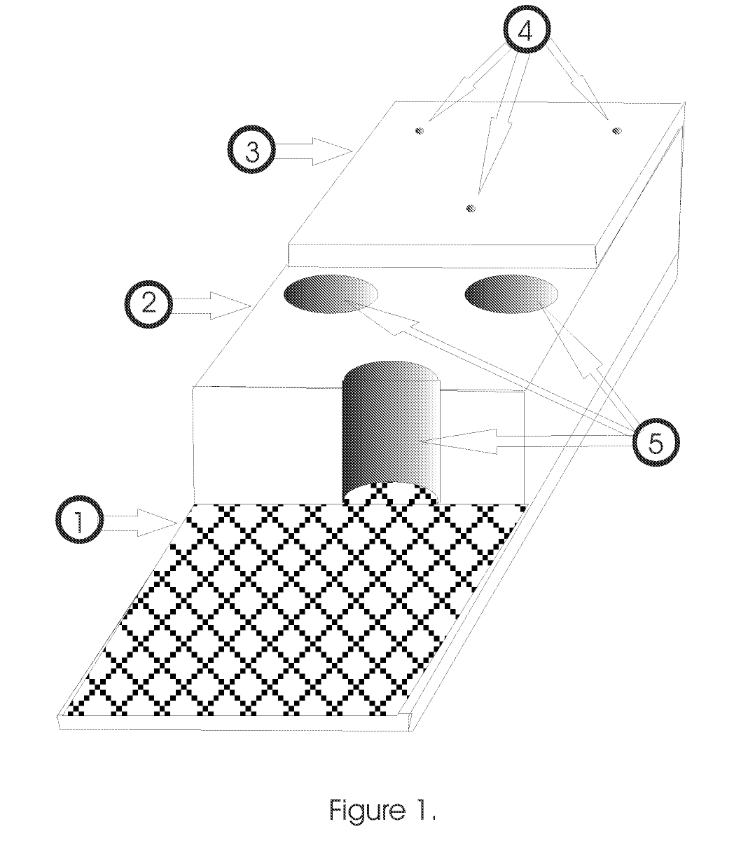

FIG. 2. shows how several lasers (20) may be arranged so that their individual beams of light cross at a specific point in space (10) creating a pixel which can display different colors in different directions at the same time. FIG. 2. also shows that this concept can be replicated to create multiple pixels.

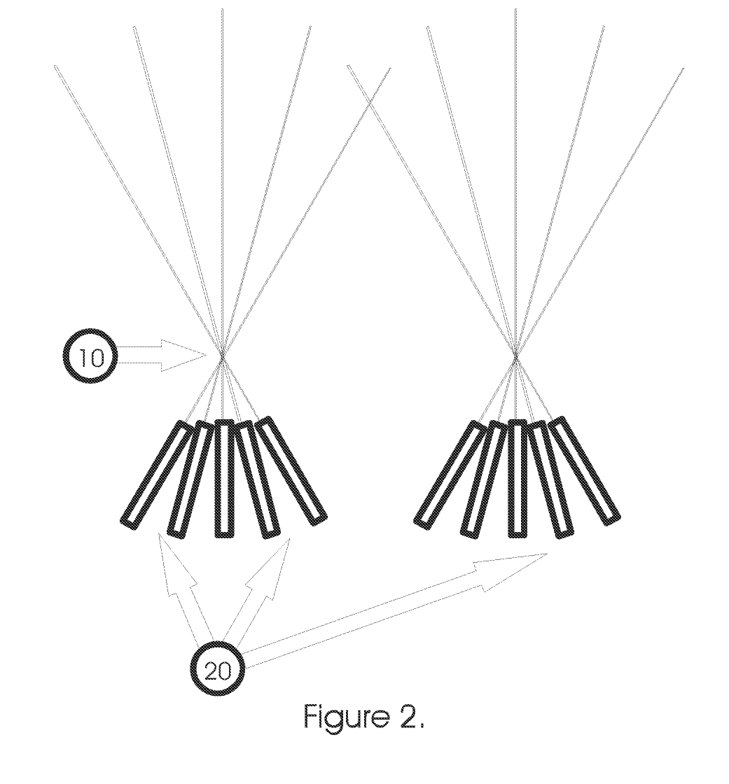

### DETAILED DESCRIPTION OF THE INVENTION

Using techniques well known to those knowledgeable in the prior arts, you can construct a Parallax Display Screen by the following steps:

1. Build up a grid of light emitting diodes complete with the wiring to power and address them each individually.

2. Cover the diodes with an opaque layer.

3. Cover that with a thin but strong opaque layer.

4. Make a pattern of small holes in the strong opaque layer.

5. Etch caverns behind each of the small holes, exposing the light emitting diodes.

6. Add a clear layer to seal and protect the caverns and their apertures.

In like manner, you can construct a Parallax Camera by the following steps:

1. Build up a grid of photo receptors complete with the wiring to power and address each of them individually.

2. Cover the receptors with an opaque layer.

3. Cover that with a thin but strong opaque layer.

4. Make a pattern of small holes in the strong opaque layer.

5. Etch caverns behind each of the small holes, exposing the receptors.

6. Add a clear layer to seal and protect the caverns and their apertures.

In the preferred embodiment, the base grid will contain a mixture of receptors and emitters. Thus, the resulting screen is both a receiver and a displayer of directed video information.

The feedback between the emitters and the receptors can be minimized by several means, such as segregating the emitters and receptors into dedicated caverns, or multiplexing them in time.

By simply mapping the receptors to the emitters in different ways, we can make this preferred embodiment function in many different ways. For instance, it can behave like a mirror—when you raise your right hand the person being displayed raises their left hand. Or, it can be mapped to behave like a mirror without the mirror-imaging—when you raise your right hand the person being displayed also raises their right hand. By varying the pattern we use for mapping the individual light receptors onto the individual sources of light, we can create many types of transformations.

By applying Parallax Camera and Display Screens to architectural features such as walls, ceilings, floors, and fences, these features could be made to appear transparent. Imagine the security and privacy we gain when we use Parallax Camera and Display Screens to create one-way windows, or doors that we can look out through while not allowing anyone on the outside to see in.

In the hands of a skilled artist, the Parallax Display Screen can be made to behave in ways well beyond the simple imitating of the parallax inherent in a window or a mirror. For example, it could hyper-zoom. As the viewer moves slightly closer to the screen, the scene being displayed could be massively zoomed closer. Or, as the viewer moved slightly to the side, the scene could swing all the way around to show the backside of the object.

It is natural to think of the image being displayed as if it is behind the Parallax Display Screen. This is a limitation of the images gathered by the described Parallax Camera, and is not a limitation inherent in the Parallax Display Screen which, in the hands of a skilled artist, can project different images to the location of each eye of the viewer, allowing for a Three-Dimensional image to appear to float in front of the display screen.

The information received by the receptors in a Parallax Camera can be transmitted and mapped onto the emitters in a physically separate Parallax Display Screen.

It is well known that color images take more space to store, and more bandwidth to transmit, than do black and white images. In an analogous way, the images of the Parallax Display Screen and Camera contain the additional directional information, which will require specialized techniques for handling that additional information.

In particular, it may be valuable to sort the pixels and their directional components such that all the sources of light which converge on a specific viewing location are handled as a single observational plane. In addition to the opportunity for compression that such a sorting would provide, such single observational planes could be displayed on the non-parallax display screens of the prior art. And, two such observational planes could be displayed on the stereoscopic display screens of the prior art.

In this patent document, the phrase “comprised of” is used in its non-limiting sense to mean the items following the phrase are included, but items not specifically mentioned are not excluded. A reference to an element by the indefinite article “a” does not exclude the possibility that more than one of the element is present, unless the context clearly requires that there be one and only one of the elements. The word “attenuated” is used to describe photons travelling roughly in parallel.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A Display Screen comprised of multiple pixels, with each such pixel comprised of multiple sources of light, with each such source of light attenuated to its specific direction.

2. A Camera comprised of multiple pixels, with each such pixel comprised of multiple receptors, with each such receptor limited to detect light from only its specific direction.

3. An information processing means for manipulating parallax video information, such parallax video information comprised of a directional component specifying the direction in which the light is attenuated.

4. The Display Screen of claim 1, combined with additionally one or more pixels which can be viewed from multiple directions.

5. The Display Screen of claim 1, with one or more such pixels comprised of multiple receptors, with each such receptor limited to detect light from only its specific direction.

6. The Display Screen of claim 1, additionally interleaved with multiple receptor pixels, with each such receptor pixel comprised of multiple receptors, with each such receptor limited to detect light from only its specific direction.

7. The Display Screen of claim 1, with at least one source of light comprised of a laser.

8. The Display Screen of claim 1, with at least one source of light being attenuated by passing through a mask.

9. The Display Screen of claim 1, with at least one group of the multiple sources of light being derived from a single source of light by beam splitting.

10. The Camera of claim 2, interleaved with multiple display pixels, each such display pixel comprised of multiple sources of light, with each source of light attenuated to its specific direction.

11. The Camera of claim 2, with at least one such pixel comprised of multiple sources of light, with each such source of light attenuated to its specific direction.

12. The Information Processing Means of claim 3, comprised of a means to compress such parallax video information by exploiting the fact that there are more sources of light than there are pixels, and therefore more sources of light than can be viewed from any single point of observation.

13. The Information Processing Means of claim 3, comprised of a means to compress such parallax video information by exploiting the fact that the consistency within the image viewed from any single point of observation is more important than the consistency between the images viewed from different points of observation, especially if those different points of observation do not match the distance between a pair of human eyes.

14. The Information Processing Means of claim 3, comprised of a means to compress such parallax video information by exploiting the fact that there are more points from which to observe than there are sources of light, and yet from every point of observation we can see the light from multiple pixels, therefore a single source of light produces photons which pass through multiple observation points.

15. The Information Processing Means of claim 3, comprised of a means to compress such parallax video information by exploiting the fact that the image captured by a parallax camera is constrained to be a representation of a three dimensional reality.

16. The Information Processing Means of claim 3, comprised of means to correct errors in such parallax video information by exploiting the fact that the image received by a parallax camera is constrained to be a representation of a three dimensional reality.

17. The Information Processing Means of claim 3, comprised of a means to correct errors in such parallax video information by exploiting the fact that the image received by a parallax camera is constrained by the reality around it.

18. The Directional Component of claim 3, comprised of two values, one for the deflection and the other for the rotation of the beam of deflected light.

19. The Directional Component of claim 3, comprised of a value for the vertical deflection and a value for the horizontal deflection.

20. The Directional Component of claim 3, comprised of the location of the source of light and the location of the observation point.
